(19) United States
(12) Patent Application Publication
(10) Pub. No.: US 2020/0268035 A1
(43) Pub. Date: Aug. 27, 2020

(54) PRINTED IMAGE AND BARRIER FOR USE WITH BEVERAGE AND RELATED PROCESS

(71) Applicant: Josh Rosenthal, Poneto, IN (US)

(72) Inventor: Josh Rosenthal, Poneto, IN (US)

(21) Appl. No.: 16/797,314

(22) Filed: Feb. 21, 2020

Related U.S. Application Data
(60) Provisional application No. 62/808,437, filed on Feb. 21, 2019.

(51) Int. Cl. A23P 20/20; A23C 9/152; A23C 9/156

(52) U.S. Cl. CPC A23P 20/20; A23C 9/1524; A23P 30/40; A23V 2002/00; A23C 9/156

(57) ABSTRACT

A beverage assembly includes a lower layer of consumable beverage, an upper layer including a printed image, and an intermediate layer between the upper layer and the lower layer. The intermediate layer is an edible foam adapted to prevent the upper layer from dissolving in the lower layer. The edible foam is hydrophobic and may maintain a boundary between the upper layer and the lower layer for approximately 1-2 hours or more.

This application claims the benefit of U.S. Provisional Patent Application Ser. No. 62/808,437, filed Feb. 21, 2019, the disclosure of which is incorporated herein by reference.

### TECHNICAL FIELD

This document relates generally to the beverage arts and, in particular, a beverage assembly.

### BACKGROUND

In the market of event planning, specialty beverages are an important aspect of specialty events. Beverage services in the context of special events may occur at locations such as hotels and banquets as well as in private venues.

One particular type of specialty beverage is a beverage in which an image is located on top of the beverage. The placement of such an image offers a visual appeal beyond the simple consumption aspect of the beverage. For example, in the specialty coffee market, images may be directly printed or otherwise created on the top of a foam, such as on top of a cappuccino or latte.

When placing an image on top of a beverage, the intent is for the images to remain on top of the beverage for as long as possible without being compromised by the underlying beverage. Early efforts at placing an image on top of a beverage, such as a cocktail, included placing the image on top of a whipped egg white mixture, such as an egg white mixed within a cocktail, as well as placing an image on top of a beverage or cocktail's natural froth. Other early efforts have included the use of emulsifications including vegetable glycerin and sugars.

These early efforts were limited by the size of the image which could be placed on the beverage and the amount of time the image could be preserved. For example, these early efforts allowed no more than approximately 10-18 minutes of an image remaining on top of a beverage before the froth, and hence the image, would begin to dissipate within the drink. Additionally, the size of images that could be placed on top of beverages were limited to images smaller than 2.5 inches, as larger images would become unstable and would quickly dissolve. Additionally, the dissolving of edible inks used in the printing of such images within the beverage itself after the image had dissolved resulted in discoloration of the beverage as well as floating particles within the beverage, such as from broken down edible paper.

Accordingly, a need is identified for an improved beverage assembly which is able to accommodate larger sized images and preserve said images for a greater period of time.

### SUMMARY

According to one aspect of the disclosure, a beverage assembly within a container comprises a lower layer within the container comprised of liquids miscible with water, an upper layer within the container comprising a printed image having a diameter of 2.5 inches or great, and a layer of edible foam between the upper and lower layer. The layer of foam may prevent the lower layer of liquids from interacting with the printed image of the upper layer for a period of at least one hour. In another embodiment, the layer of foam may prevent the lower layer of liquids from interacting with the printed image of the upper layer for a period of at least two hours. In one aspect, this foam may prevent the lower layer of liquids from interacting with the printed image of the upper layer for more than 1 hour at room temperature.

In one aspect, the layer of foam may be hydrophobic. The foam may further comprise between 50-55% sucrose, or between 0.28-0.32% xanthan gum.

In another aspect, the lower layer of liquids comprises alcohol, and the printed image comprises edible ink. The layer of foam may also be adapted to be shelf-stable. Furthermore, the upper layer may comprise an edible wafer, wherein the printed image is printed on the edible wafer.

In a further aspect, the layer of foam is adapted to float on top of the lower layer of liquids in such a manner that a user may tilt the container to access the lower layer of liquids without displacing the printed image.

According to a further embodiment, a method of assembling a beverage is disclosed. The method comprises pouring a lower layer of liquids miscible with water into a container, expelling a layer of edible foam on top of the lower layer of liquids, and placing a printed image having a diameter of at least 2.5 inches on top of the intermediary layer of foam. The intermediary layer of foam may form a boundary between the lower layer of liquids and the printed image for at least one hour. In one aspect, the layer of foam may form a boundary for at least two hours.

In another aspect, the expelling step may involve expelling a layer of hydrophobic foam on the lower layer of liquid. Furthermore, the expelling step may involve expelling a foam comprising between 0.28-0.32 xanthan gum onto the lower layer of liquid. The lower layer of liquids may comprise alcohol and the printed image of the upper layer may be printed using edible ink.

In another embodiment, the intermediary foam expelled on the lower layer of liquids may be shelf-stable. The printed image, which is placed on the lower layer of liquids, may be printed on an edible wafer. The edible wafer may be adapted as to be peeled from a paper backing.

### BRIEF DESCRIPTION OF THE DRAWING FIGURES

The accompanying drawing figures incorporated herein and forming a part of the specification, illustrate several aspects of the cage fan according to the disclosure and, together with the description, serve to explain certain principles thereof. In the drawing figures:

FIG. 1 is a front view of a completed beverage assembly;

FIG. 2 is a front view of the completed beverage assembly during use by a customer.

Reference will now be made in detail to certain embodiments, examples of which are illustrated in the accompanying drawing figures.

### DETAILED DESCRIPTION

The following description of certain examples of the invention should not be used to limit the scope of the disclosure. Other examples, features, aspects, embodiments, and advantages of the invention will become apparent to those skilled in the art from the following description, which includes by way of illustration, one or more of the best modes contemplated for carrying out the invention. As will be realized, the invention is capable of other different and obvious aspects, all without departing from the invention. Accordingly, the drawings and descriptions should be regarded as illustrative in nature and not restrictive.

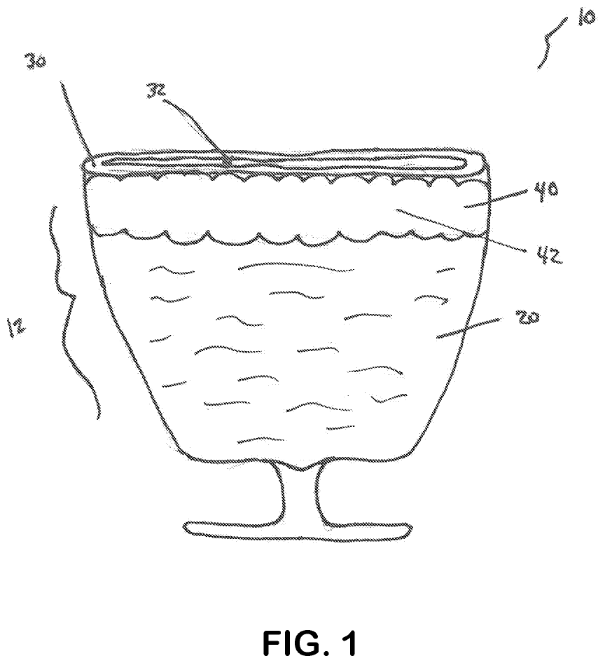

Reference is now made to FIG. 1, which illustrates a beverage assembly 10. The beverage assembly 10 may comprise a lower layer 20 which may include consumable liquids which may be miscible with water. These consumable liquids may be polar in nature, such as aqueous beverages, alcohol-based beverages, and combinations thereof. The beverage assembly 10 may further include an upper layer 30 comprising a printed image 32. An intermediary layer 40 of an edible foam 42 exists between the upper layer 30 and the lower layer 20, and prevents the lower layer 20 of liquids from interacting with the printed image of the upper layer 30. In some embodiments the edible foam 42 may prevent the lower layer 20 from interacting with printed image 32 for a time period of at least 1 hour, and in some embodiments, for over 1.5 hours or over 2 hours.

In preparing the beverage assembly 10, a lower layer 20 of liquids is poured into a container 12, wherein the container 12 may have a diameter of at least 2.5 inches. Once the lower layer 20 of liquids is settled in the container 12, the intermediary layer of foam 40 may be expelled on top of the lower layer 20 of liquids.

The intermediary layer 40 of foam 42 may be expelled on the lower layer 20 of liquids in such a manner as to immediately spread out and expand across the lower layer 20 of liquid to create a flat, horizontal, and level surface. One way of ensuring that the intermediary layer 40 of foam 42 behaves in this manner is by utilizing certain ingredients and methods of making the foam.

In one embodiment, the foam 42 may comprise between 33-35% deionized water. The foam 42 may further comprise 50-55% sucrose. In another aspect, the foam 42 may comprise 0-0.52.% methyl cellulose. In a further aspect, 0.28-0.32% xanthan gum (food grade) may be included in the foam. The foam 42 may further comprise 9-10% vegetable glycerin. The foam 42 may also include 0.13-0.26% soy lecithin. In another aspect, the foam 42 may comprise 0.12-0.15% citric acid. The foam may comprise 0.12-0.15% maltodextrin. All percentages are mass percentages.

Furthermore, the foam 42 may be manufactured on a large scale, such as in roughly 300 gallon batches, prior to being canned, as outlined below. In manufacturing the foam 42, the deionized water may first be placed in a clean, sanitized tank, and a mixer may be used to stir the water at a slow speed, such as up to 800 revolutions per minute (“rpm”). Powdered methyl cellulose may be added to the water, and the speed of the mixer may be increased to continue agitation of the liquid batch. The mixing step may be continued until the powdered methyl cellulose is solubilized by the water.

Once the methyl cellulose is solubilized, powdered xanthan gum may be added to the tank, and the speed of the mixer may be increased to high speed, between 1600-2400 rpm. The agitation of the liquid batch may continue at high speed until the powdered xanthan gum is solubilized, at which point the speed of the mixer is reduced to slow speed, such as less than 800 rpm.

Sucrose may be slowly added to the tank, while the mixer continues to agitate the liquid batch at slow speed. Once the sucrose is added, the tank may be heated using steam and/or hot water circulation until the Sucrose is fully dissolved in the liquid batch. The tank may be continuously heated until it reaches a temperature of 80 degrees Celsius for a period of 5 mins.

Once the sucrose is fully dissolved, the batch may be cooled to a temperature of 40 degrees Celsius over a period of 1 to 3 hours. During the cooling process, the liquid batch may be mixed by the mixer at a moderate speed, such as between 800-1600 rpm.

Soy lecithin, citric acid, and maltodextrin may all be added to the tank as the moderate mixing of the liquid batch continues. The speed of the mixer may then be increased to operate at high shear speed and continue to mix the batch for 20 minutes. After 20 minutes, the mixer speed may be reduced to slow, and the batch may be chilled to 20 degrees Celsius. The batch may then be maintained at 20 degrees Celsius for a period of 6 hours.

After the batch has been properly chilled, the liquid batch may be canned in a pressurized and commercial food grade cannister 44, such as a whipped cream can or a whipping siphon. During canning, 8 g of nitrogen dioxide may be added to the cannister 44 for each 2 mL of liquid batch. The mixture of nitrogen dioxide and liquid batch may be agitated in order to allow the nitrogen dioxide to effectively mix with the liquid batch.

Combining the nitrogen dioxide and liquid batch allows the liquid batch to stabilize. When the resulting mixture is expelled from the cannister 44, the mixture is emulsified, and the foam 42 is formed. The foam 42 has reduced nitrous oxide separation, which allows the foam 42 to immediately expand across the lower layer 20 of liquid and create a flat, horizontal, and level surface. As a result, a user may only expel a small amount of the foam 42 onto the top of the lower layer of liquid 20 given its natural expansion on contact with the layer of liquid.

In one aspect, the resulting foam 42 may be prepared in such a manner that it is shelf-stable in the cannister 44, and thereby does not require refrigeration to avoid spoiling. For the purpose of this disclosure, the term “shelf-stable” means that the foam has a water activity of level of between 0.60-0.85, a pH range of 4.6-5.2, and a Brix of 50-65.

In another aspect, the resulting foam 42 may be a non-polar hydrophobic foam, such that is does not mix with the lower layer 20 of liquids. Instead, the foam 42 may act as a platform which remains stable on top of the lower layer 20 of liquid for a period of at least 1-2 hours.

Once the foam 42 has been placed on top of the lower layer 20 of liquids, the intermediary layer 40 of foam 42 may be able to receive the upper layer 30 comprising a printed image 32. In one aspect the printed image 32 may be 2.5 inches in diameter or greater, and may comprise edible ink. The size of the printed image 32 may be selected based on the size of the container 10 in which the beverage is to be served.

The printed image 32 may be printed on an edible wafer, which may comprise sugars, starches, gum, and/or other minor binding agents. The edible wafer may be placed on a spool of paper, such as a plastic paper, which is adapted to be placed inside of a printer, such as a specialized printer specifically adapted to receive the paper. The edible wafer may comprise a frosting layer upon which the image may be printed. In practice, the edible wafer including the image may be removed from the paper for placement on the beverage assembly. In one embodiment, the printed image 32 comprises a printed disc, however, the image may alternatively take the form of other shapes.

The printer may utilize an edible ink cartridge to print the printed image 32 onto the edible wafer. The edible wafer including the printed image 32 may be releasably attached to the paper, such that the wafer and printed image 32 may be peeled from the paper and placed on top of the intermediary layer 40 of foam 42. Once the printed image 32 is placed on the intermediary layer 40 of foam 42, the wafer and printed image 32 may settle into the foam 42, and will be effectively preserved for a period of at least 1-2 hours.

When assembled, the container 12 may be filled with the lower layer 20 to approximately ⅓ inch from the top of the container 12. The intermediary layer 40 of foam 42 may have a height of approximately ½ inch, and the upper layer 30 with the printed image 32 may rest on top of the foam 42.

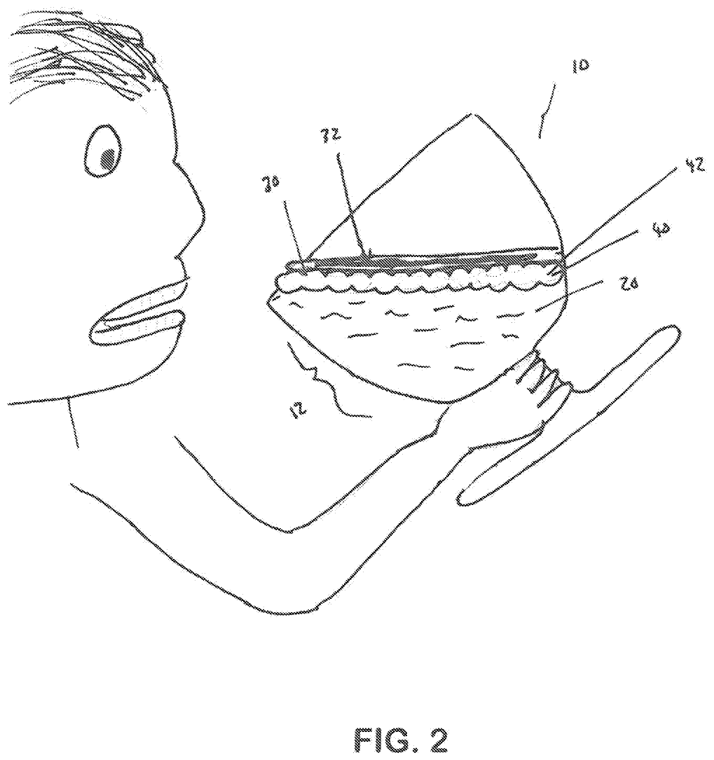

As is illustrated in FIG. 2, when the beverage assembly 10 is fully assembled, the intermediary layer 40 of foam 42 acts as a buoy between the lower layer 20 of liquids and the upper layer 30. The buoy-effect of the foam 42 allows the printed image 32 to remain stable and preserved even when a user drinks from the beverage assembly 10. For example, this buoy-effect may allow the printed image to remain positioned in a horizontal plane within the container 12 while the container is tilted to the side and while the lower layer 20 is simultaneously released from the container 12, beneath the foam 42. As a user tilts the beverage assembly 10 toward their mouth, the foam 42 remains level, which allows the lower layer 20 of liquid to escape the side of the container 12 without disrupting the upper layer 30 or the printed image 32.

The foregoing disclosure has been presented for purposes of illustration and description. It is not intended to be exhaustive or to limit the embodiments to the precise form disclosed. Obvious modifications and variations are possible in light of the above teachings. As can be appreciated, the sensor module 12a may be adapted for use with existing fans in a retrofit situation without extensive modification. All such modifications and variations are within the scope of the appended claims when interpreted in accordance with the breadth to which they are fairly, legally and equitably entitled.

What is claimed:

1. A method of assembling a beverage comprising:
pouring a lower layer of liquids miscible with water into a container;
expelling a layer of edible foam on top of the lower layer of liquid;
placing an edible wafer comprising a printed image on top of the intermediary layer of foam;
wherein the intermediary layer of foam forms a boundary between the lower layer of liquid and the edible wafer comprising the printed image for at least one hour.

2. The method of claim 1, wherein the layer of edible foam is non-polar.

3. The method of claim 1, wherein the layer of edible foam is hydrophobic.

4. The method of claim 1, wherein the layer of edible foam comprises between 0.28-0.32% xanthan gum.

5. The method of claim 1, wherein the lower layer comprises alcohol.

6. The method of claim 1, wherein the edible wafer is at least 2.5 inches in diameter.

7. The method of claim 1, wherein the printed image comprises edible ink.

8. The method of claim 1, wherein the layer of edible foam is shelf-stable.

9. The method of claim 1, wherein the layer of foam floats on top of the lower layer of liquids in such a manner that a user may access the lower layer of liquid without displacing the intermediary layer of foam.

10. The method of claim 1, wherein the expelling step comprises expelling the edible foam on top of the lower layer of liquid using a whipping siphon.

11. The method of claim 10, wherein the edible foam is shelf-stable.

12. The method of claim 1, further including the step of printing the printed image on the edible wafer.

13. The method of claim 1, wherein the placing step comprises peeling the edible wafer from a paper backing.

14. The method of claim 1, wherein the intermediary layer of foam forms a boundary between the lower layer of liquid and the printed image for at least two hours.

15. The method of claim 1, wherein the intermediary layer of foam forms a boundary between the lower layer of liquid and the edible wafer comprising the printed image for at least one hour at room temperature.
